(19) United States
(12) Patent Application Publication
(10) Pub. No.: US 2015/0207778 A1
(43) Pub. Date: Jul. 23, 2015

(54) METHOD, SYSTEM AND COMPUTER-READABLE RECORDING MEDIA FOR PROVIDING SERVICE SELECTIVELY IN WEBINOS PLATFORM

(71) Applicant: Obigo Inc., Gyeonggi-do (KR)

(72) Inventors: Se Kwon Jang, Gyeonggi-do (KR); Jae Yong Lim, Seoul (KR); Jwa Jin Kim, Seoul (KR); Seung Bok Ryu, Seoul (KR); Jong Min Moon, Seoul (KR)

(73) Assignee: Obigo Inc., Gyeonggi-do (KR)

(21) Appl. No.: 14/260,640

(22) Filed: Apr. 24, 2014

(30) Foreign Application Priority Data
Jan. 22, 2014 (KR) 10-2014-0007591

(51) Int. Cl. H04L 29/06

(52) U.S. Cl. CPC H04L 63/00

(57) ABSTRACT

The present invention relates to a method for providing a service selectively in a webinos platform. The method includes steps of: (a) encrypting a service name corresponding to a PZP belonging to a first personal zone with a specific key while the PZP to the first personal zone is registered in a PZH in the first personal zone and a PZP to a second personal zone is registered in a PZH in the second personal zone; (b) allowing the PZH in the first personal zone to publish the service name encrypted with the specific key; and (c) allowing the PZH in the second personal zone to search the service name encrypted with the specific key by the first personal zone among at least one published service name in at least one personal zone by referring to information on the specific key received from the PZH in the first personal zone.

### CROSS REFERENCE TO RELATED APPLICATION

This application claims priority to and incorporates herein by reference all disclosure in Korean Patent Application No. 10-2014-0007591 filed Jan. 22, 2014.

### FIELD OF THE INVENTION

The present invention relates to a method, a system and a computer-readable media for providing a service selectively in a webinos platform; and more particularly, to the service method, the system and the computer-readable media for encrypting a service name corresponding to a personal zone proxy (PZP) belonging to a first personal zone with a specific key while the PZP to the first personal zone is registered in a personal zone hub (PZH) in the first personal zone and a PZP to a second personal zone is registered in a PZH in the second personal zone, allowing the PZH in the first personal zone to publish the service name encrypted with the specific key, and allowing the PZH in the second personal zone to search the service name encrypted with the specific key by the first personal zone among at least one published service name in at least one personal zone by referring to information on the specific key received from the PZH in the first personal zone to enable a service provider to provide the service selectively and enable a service user to search and use the service conveniently.

### BACKGROUND OF THE INVENTION

Webinos is a web-based platform that provides applications and services run in a variety of devices and it provides a service discovery function to offer mobility about platforms to a variety of devices.

The service discovery function of the webinos is a function of mapping a desired service by finding the service on a network in a course of connecting to a PZP that provides the service by finding or querying the service to use when the PZP is registered to a personal zone and the service is published

By the way, if device A intends to provide a service to device B, a service becomes published. Because it is also published to other devices, the service happens to be published even to a device to which it is unsought to be published. To solve the problem, there is a method for allowing the device B to find the service during a fixed time during which the device A publishes the service but because the service name is exposed, a request for the service may be made by the device to which the service is unsought to be published. In addition, an additional authentication process may be considered to solve the problem, but the service becomes less convenient due to the authentication process.

Besides, if there are devices that provide similar or same services, and the service names are similar, it could take a lot of time to find a service of a desired specific device or it could find an unsought service of a different device.

### SUMMARY OF THE INVENTION

It is an object of the present invention to solve all the problems mentioned above.

It is another object of the present invention to encrypt a service name with a promised key to allow a service provider to provide a service selectively and allow a service user to search the service conveniently.

In accordance with one aspect of the present invention, there is provided a method for providing a service selectively in a webinos platform, including steps of: (a) encrypting a service name corresponding to a personal zone proxy, or shortly PZP, belonging to a first personal zone with a specific key while the PZP to the first personal zone is registered in a personal zone hub, or shortly PZH, in the first personal zone and a PZP to a second personal zone is registered in a PZH in the second personal zone; (b) allowing the PZH in the first personal zone to publish the service name encrypted with the specific key; and (c) allowing the PZH in the second personal zone to search the service name encrypted with the specific key by the first personal zone among at least one published service name in at least one personal zone by referring to information on the specific key received from the PZH in the first personal zone.

In accordance with another aspect of the present invention, there is provided a system for providing a service selectively in a webinos platform while a PZP belonging to a first personal zone is registered in a first personal zone and one belonging to a second personal zone is registered in a second personal zone, including: a personal zone hub, or shortly PZH, in the first personal zone for encrypting a service name corresponding to the PZP belonging to the first personal zone with a specific key and publishing the service name encrypted with the specific key; and a PZH in the second personal zone for searching the service name encrypted with the specific key by the first personal zone among at least one published service name in at least one personal zone by referring to information on the specific key transferred from the PZH in the first personal zone.

### BRIEF DESCRIPTION OF THE DRAWINGS

The above and other objects and features of the present invention will become apparent from the following description of preferred embodiments given in conjunction with the accompanying drawings, in which:

FIG. 1 shows a service providing system of a webinos platform in accordance with one example embodiment of the present invention.

FIG. 2 represents a service providing system according to a conventional technology.

FIG. 3 shows the service providing system in accordance with an example embodiment of the present invention.

### DETAILED DESCRIPTION OF THE PREFERRED EMBODIMENTS

The detailed description of the present invention illustrates specific embodiments in which the present invention can be performed with reference to the attached drawings.

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the present invention, although different, are not necessarily mutually exclusive. For example, a particular feature, structure, or characteristic described herein in connection with one embodiment may be implemented within other embodiments without departing from the spirit and scope of the present invention. In addition, it is to be understood that the location or arrangement of individual elements within each published embodiment may be modified without departing from the spirit and scope of the present invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

To allow those skilled in the art to the present invention to be carried out easily, the example embodiments of the present invention by referring to attached diagrams will be explained in detail as follows:

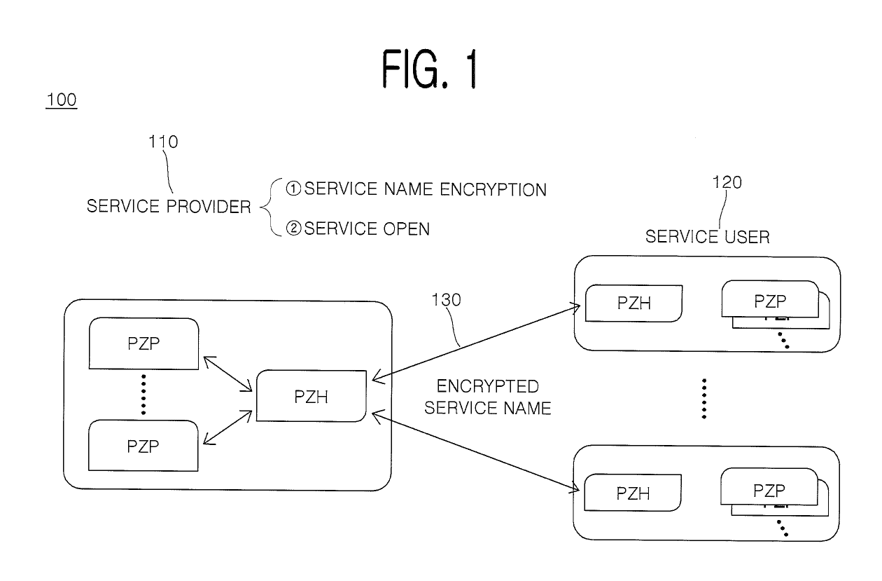

FIG. 1 shows a service providing system of a webinos platform in accordance with one example embodiment of the present invention and a system 100 may include a service provider 110 and a service user 120.

The service provider 110 may encrypt a service name and publish a service. In addition, more specifically, individual devices that provide or use the service may have individual software environments called personal zone proxies (PZPs) and the PZP of each device may be registered in a personal zone as a concept similar to a cloud and each personal zone may include at least one PZP. Besides, each personal zone may include one personal zone hub (PZH), which is connected with the PZP in the personal zone where the PZH belongs, and may support a connection with another personal zone to which the PZH does not belong.

First of all, a method for providing the service selectively in the webinos platform by using FIG. 1 can be explained as follows:

A PZP of the service provider 110 may be registered in the personal zone to be connected with the PZH and a name of a service of the PZP encrypted with a promised key may be published as an encrypted service name 130. Even the service user 120 may be connected with the PZP of the service provider 110 and receive a desired service by querying or searching the service with the service name 130 encrypted with the promised key. In addition, another user may receive the desired service by querying or searching with the service name 130 encrypted with the promised key.

The encrypted service name 130 may be in a numerical form such as a form of binary numeral or hexadecimal number. It may also be in a form of decimal number and character or special character, but it is not limited to these.

As mentioned above, the service provider 110 may provide the service by encrypting the service name with the promised key and publishing it with the encrypted service name 130, but it could also be introduced that the service user receives or uses a matched service by encrypting and querying or searching a service name other than the encrypted service name 130.

Besides, even the service user 120 could be served as a service provider on the contrary to its role in using the service. In the case, it could also encrypt a service name other than the encrypted service name 130 and publish it and then provide the service.

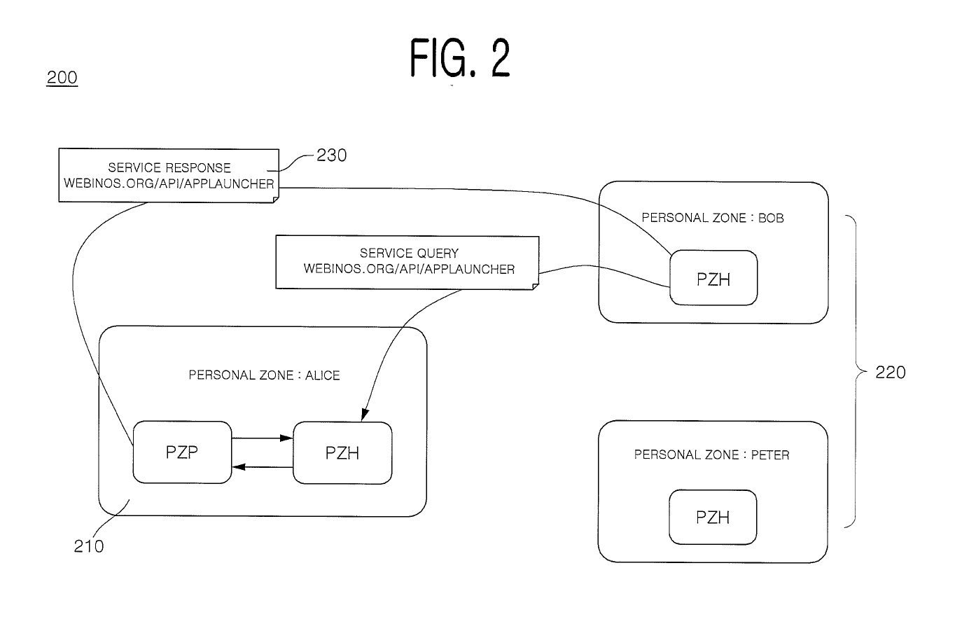

FIG. 2 represents a service providing system according to a conventional technology. If a PZP is registered in a personal zone 210 of a service provider and a PZH in a personal zone 220 of a service user outside of the personal zone 210 queries ‘webinos.org/api/applauncher’ as a service name 230, the service could be received in connection to the PZP in the personal zone 210. As another user can get the service equally by querying or searching ‘webinos.org/api/applauncher’ as the service name 230, many users whom the service provider does not want can get the service by being connected to the PZP.

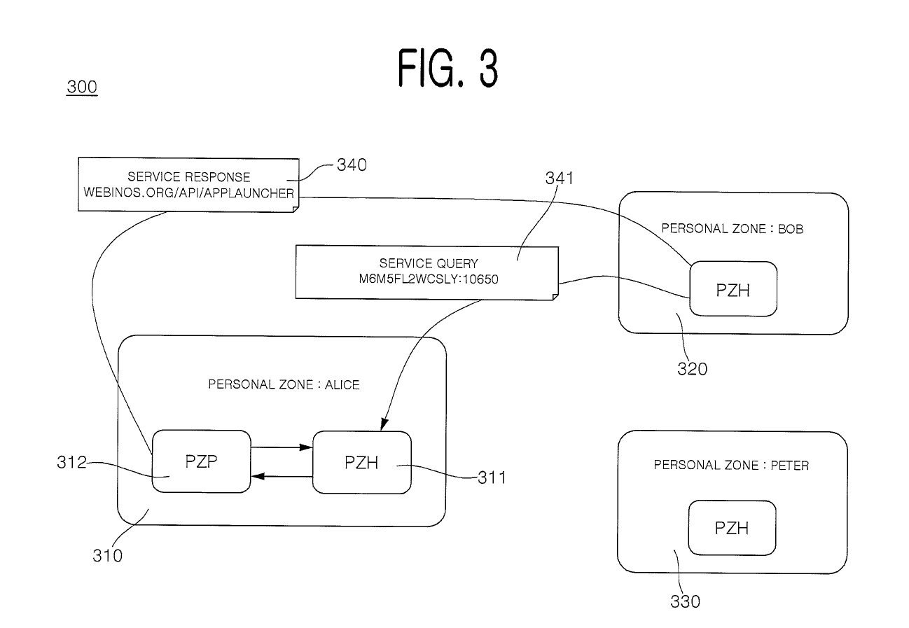

FIG. 3 illustrates a method for providing a service selectively in the webino platform in accordance with an example embodiment of the present invention.

More specifically, when the service provider registers a PZP 312 in a first personal zone 310 and publishes a service with an encrypted service name 341 to which a service name 340 is encrypted with a promised key, only service users who have queried or searched with the encrypted service name 341 could get the service through the PZH in the second personal zone 320.

For example, the service name 340 may be ‘webinos.org/api/applauncher’ in a form of character and the encrypted service name 341 may be in a form of password, such as ‘M6M5FL2wCs1Y:10650’, which is listed as characters or numbers instead of words commercially used in the general community. As mentioned above, it could be in a form of hexadecimal number or special character, but it is not limited only to these.

In accordance with the present invention, the service provider may prevent a service from being provided to a service user to whom the service provider does not want to provide the service. For example, even if a PZH in a third personal zone 330 queries or searches ‘webinos.org/api/applauncher’ as the service name 340 that the service user happens to know, because the published service name is ‘M6M5FL2wCs1Y:10650’ as the encrypted service name 341, it is really difficult to receive the published service with the encrypted service name in a completely different type or form by asking or searching with the service name 340.

In accordance with the present invention, since a PZH 311 in the first personal zone may provide a service for a plurality of service users by encrypting the service name 340 with different keys, it may prevent keys from being shared with irrelevant service users by making the keys different among the plurality of service users. Accordingly, since the service provider can group relevant users to whom the service provider wants to provide the service, the service provider may provide the service to a group of desired users and if changing a key, the service provider could also change the service providing status to stop the service from being provided or to resume the service.

Besides, if same or similar service names are encrypted with different keys and the service name encrypted with the promised key(s) is published through a PZH(s) in multiple personal zones or one personal zone, since the user(s) may query or search with the service name encrypted with the promised key(s), the user could connect to the desired service without any confusion.

In accordance with the present invention, since a service provider provides a service selectively by encrypting the service name with the promised key, a service user can search and use the service conveniently.

In accordance with the present invention, even if the service is published, it is published at an encrypted status. Therefore, most users could be prevented from perceiving which service it is.

The embodiments of the present invention as explained above can be implemented in a form of executable program command through a variety of computer means recordable to computer readable media. The computer readable media may include solely or in combination, program commands, data files, and data structures. The program commands recorded to the media may be components specially designed for the present invention or may be usable to a skilled person in a field of computer software. Computer readable record media include magnetic media such as hard disk, floppy disk, and magnetic tape, optical media such as CD-ROM and DVD, magneto-optical media such as floptical disk and hardware devices such as ROM, RAM, and flash memory specially designed to store and carry out programs. Program commands include not only a machine language code made by a complier but also a high level code that can be used by an interpreter etc., which is executed by a computer. The aforementioned hardware device can work as more than a software module to perform the action of the present invention and they can do the same in the opposite case.

As seen above, the present invention has been explained by specific matters such as detailed components, limited embodiments, and drawings. While the invention has been shown and described with respect to the preferred embodiments, it, however, will be understood by those skilled in the art that various changes and modification may be made without departing from the spirit and scope of the invention as defined in the following claims.

Accordingly, the thought of the present invention must not be confined to the explained embodiments, and the following patent claims as well as everything including variations equal or equivalent to the patent claims pertain to the category of the thought of the present invention.

What is claimed is:

1. A method for providing a service selectively in a webinos platform, comprising steps of:
(a) encrypting a service name corresponding to a personal zone proxy, or shortly PZP, belonging to a first personal zone with a specific key while the PZP to the first personal zone is registered in a personal zone hub, or shortly PZH, in the first personal zone and a PZP to a second personal zone is registered in a PZH in the second personal zone;
(b) allowing the PZH in the first personal zone to publish the service name encrypted with the specific key; and
(c) allowing the PZH in the second personal zone to search the service name encrypted with the specific key by the first personal zone among at least one published service name in at least one personal zone by referring to information on the specific key received from the PZH in the first personal zone.

2. The method of claim 1, wherein, if the service name searched by the PZH in the second personal zone is decided to correspond to the service name published by the PZH in the first personal zone, the PZH in the second personal zone is connected with the PZP belonging to the first personal zone corresponding to the published service name.

3. The method of claim 2, wherein, if the service name searched by the PZH in the second personal zone is decided to correspond to the service name published by the PZH in the first personal zone, the PZH in the first personal zone supports the PZH in the second personal zone to be connected with the PZP belonging to the first personal zone corresponding to the published service name.

4. The method of claim 1, wherein, if services corresponding to multiple PZPs in at least one personal zone are same, individual names of the services corresponding to the multiple PZPs are encrypted by using different keys and the encrypted individual names are published.

5. A system for providing a service selectively in a webinos platform while a PZP belonging to a first personal zone is registered in a first personal zone and one belonging to a second personal zone is registered in a second personal zone, comprising:
a personal zone hub, or shortly PZH, in the first personal zone for encrypting a service name corresponding to the PZP belonging to the first personal zone with a specific key and publishing the service name encrypted with the specific key; and
a PZH in the second personal zone for searching the service name encrypted with the specific key by the first personal zone among at least one published service name in at least one personal zone by referring to information on the specific key transferred from the PZH in the first personal zone.

6. The system of claim 5, wherein, if the service name searched by the PZH in the second personal zone is decided to correspond to the service name published by the PZH in the first personal zone, the PZH in the first personal zone supports the PZH in the second personal zone to be connected with the PZP belonging to the first personal zone corresponding to the published service name.

7. The system of claim 5, wherein, if services corresponding to multiple PZPs in at least one personal zone are same, the PZHs in the personal zone corresponding to the multiple PZPs encrypt individual service names corresponding to the multiple PZPs by using different keys and publish the encrypted individual names.

8. One or more computer-readable recording media having stored thereon a computer program that, when executed by one or more processors, causes the one or more processors to perform acts including:
(a) encrypting a service name corresponding to a personal zone proxy, or shortly PZP, belonging to a first personal zone with a specific key while the PZP to the first personal zone is registered in a personal zone hub, or shortly PZH, in the first personal zone and a PZP to a second personal zone is registered in a PZH in the second personal zone;
(b) allowing the PZH in the first personal zone to publish the service name encrypted with the specific key; and
(c) allowing the PZH in the second personal zone to search the service name encrypted with the specific key by the first personal zone among at least one published service name in at least one personal zone by referring to information on the specific key received from the PZH in the first personal zone.
